(19) United States
(12) Patent Application Publication
(10) Pub. No.: US 2023/0418294 A1
(43) Pub. Date: Dec. 28, 2023

(54) INTRUSIVE INDUSTRIAL VEHICLE ALIGNMENT

(71) Applicant: Crown Equipment Corporation, New Bremen, OH (US)

(72) Inventors: Eric Pepple, St. Henry, OH (US); Lee Wente, Minster, OH (US)

(21) Appl. No.: 18/340,332

(22) Filed: Jun. 23, 2023

Related U.S. Application Data
(60) Provisional application No. 63/366,963, filed on Jun. 24, 2022.

(51) Int. Cl. G05D 1/02; B66F 9/06

(52) U.S. Cl. CPC G05D 1/0212; G05D 1/0231; B66F 9/063

(57) ABSTRACT

A process for aligning an industrial vehicle for putaway operation comprises traveling to a position associated with a putaway location. A sensor mounted to the industrial vehicle determines whether the putaway location is empty, and if the putaway location is empty, the industrial vehicle completes a pivot maneuver such that a portion of the industrial vehicle is inside the putaway location while the pivot maneuver is in progress.

### CROSS REFERENCE TO RELATED APPLICATIONS

This application claims the benefit of U.S. Provisional Patent Application Ser. No. 63/366,963, filed Jun. 24, 2022, entitled “INTRUSIVE INDUSTRIAL VEHICLE ALIGNMENT”, the disclosure of which is hereby incorporated by reference.

### BACKGROUND

Industrial vehicles such as materials handling vehicles are commonly used for picking stock in industrial environments (e.g., warehouses and distribution centers). Such vehicles typically include a power unit and a load handling assembly, which may include load carrying forks. The vehicle also has control structures for controlling operation and movement of the vehicle.

In a warehouse or distribution center with autonomous or semi-autonomous vehicles, the vehicles are responsible for transporting goods from one location to another. For example, a vehicle may be required to transport goods from a pickup location to a putaway location.

### BRIEF SUMMARY

According to aspects of the present disclosure, a process for aligning an automated or semiautomated industrial vehicle for putaway operation comprises traveling to a position associated with a putaway location. A sensor mounted to the industrial vehicle determines whether the putaway location is empty, and if the putaway location is empty, the industrial vehicle completes a pivot maneuver such that a portion of the industrial vehicle is inside the putaway location while the pivot maneuver is in progress.

According to further aspects of the present disclosure, traveling to a position associated with a putaway location further comprises receiving an instruction to perform a putaway operation at the putaway location. Moreover, the putaway location may include a rack height, and the industrial vehicle may ensure that a load-bearing feature of the industrial vehicle is at a height associated with the rack height before determining whether the putaway location is empty. If the load-bearing feature is not at the height associated with the rack height, then the industrial vehicle adjusts the load-bearing feature to be at the height associated with the rack height.

According to more aspects of the present disclosure, the sensor is a camera and is not directed in a travel direction of the industrial vehicle (e.g., the camera is mounted on a side of the industrial vehicle).

According to still further aspects of the present disclosure, the industrial vehicle performs a predetermined action such as traveling to a different location of the industrial environment if the putaway location is not empty.

According to aspects of the present disclosure, an industrial vehicle that can perform the processes described above comprises a frame, a load-handling feature coupled to the frame, and a sensor coupled to the frame. In some embodiments, the sensor is coupled to the frame via the load-handling feature.

### BRIEF DESCRIPTION OF THE SEVERAL VIEWS OF THE DRAWINGS

FIG. 1 is a schematic of an industrial environment, according to various aspects of the present disclosure;

FIG. 2 is an illustration of an industrial vehicle in an aisle of an industrial environment, according to various aspects of the present disclosure;

FIG. 3 is an illustration of an industrial vehicle in an aisle of an industrial environment scanning a putaway location, according to various aspects of the present disclosure;

FIG. 4 is a flow chart illustrating a process for aligning an industrial vehicle for putaway operation, according to various aspects of the present disclosure; and

FIG. 5 is a block diagram of a processing system, according to various aspects of the present disclosure.

### DETAILED DESCRIPTION

An industrial environment (e.g., warehouse, distribution center, supply yard, loading dock, manufacturing facility, retail space, etc.) includes aisles and locations for stock items accessible via the aisles. In a typical stock picking operation, an operator of an industrial vehicle or an autonomous industrial vehicle fills orders from available stock items that are located in locations (e.g., storage areas) provided down one or more aisles within the industrial environment.

A rack is a structure that can be used to stock and store various items such as consumer products or materials and can vary in both size and structure. Examples of racks include, but are not limited to selective pallet racks, drive-in racks, drive-through racks, flow racks, gravity racks, and pushback racks. Racks may also have multiple vertical tiers to expand storage capacity.

During a typical stock picking operation, an operator or an autonomous industrial vehicle may travel to a first location where item(s) on a first order are to be picked. In a pick process, the operator or autonomous industrial vehicle retrieves the ordered stock item(s) from their associated storage area(s) (e.g., racks) and places the picked stock on a pallet, collection cage, other support structure carried by the industrial vehicle, or on the industrial vehicle itself. The industrial vehicle advances to the next location where subsequent item(s) are to be picked. The above process is repeated until all stock items on the order have been picked. Alternatively, the operator or automated industrial vehicle retrieves a packaged item such as a pallet, crate, box, container, or other like item with the industrial vehicle and repeats the process until all packages have been retrieved and moved to a new location (i.e., a putaway location) to be put away.

When performing a putaway operation in an industrial environment an industrial vehicle may have to change direction of travel to face a putaway location. Many autonomous and semi-autonomous industrial vehicles perform a pivot operation around a point in order to change direction to face the putaway location. Aspects of the present disclosure include a vehicle and process for performing a putaway operation that determine that a putaway location is clear before completing the pivot maneuver, which allows for the vehicle to use a portion of the empty putaway location while performing the pivot maneuver. This improvement for autonomous industrial vehicles allows for the autonomous industrial vehicles to be used in warehouses and distribution centers that autonomous industrial vehicles could not previously been used due to narrow aisles.

According to aspects of the present disclosure, when making a pivot maneuver, the autonomous vehicle utilizes a portion of the putaway location, while ensuring that any racking (i.e., rack structure) at that location is not damaged during the pivot maneuver. The vehicle uses a sensor ensure that the putaway location is clear before completing the pivot maneuver.

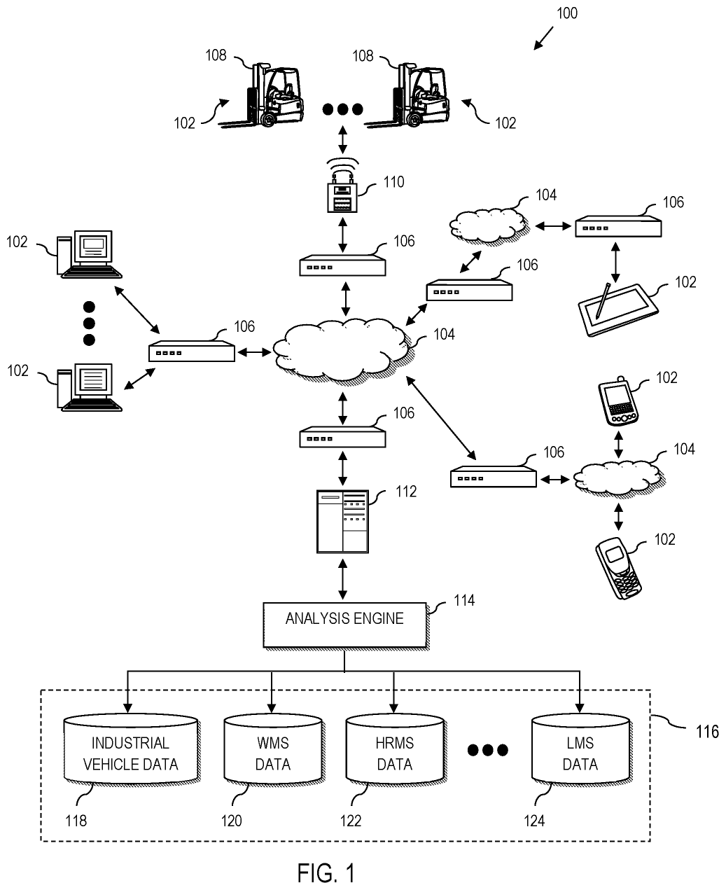

Referring now to the drawings and in particular to FIG. 1, a general diagram of a system 100 is illustrated according to various aspects of the present disclosure. The illustrated system 100 is a special purpose (particular) computing environment that includes a plurality of hardware processing devices (designated generally by the reference 102) that are linked together by one or more network(s) (designated generally by the reference 104).

The network(s) 104 provides communications links between the various processing devices 102 and may be supported by networking components 106 that interconnect the processing devices 102, including for example, routers, hubs, firewalls, network interfaces, wired or wireless communications links and corresponding interconnections, cellular stations and corresponding cellular conversion technologies (e.g., to convert between cellular and TCP/IP, etc.). Moreover, the network(s) 104 may comprise connections using one or more intranets, extranets, local area networks (LAN), wide area networks (WAN), wireless networks (Wi-Fi), the Internet, including the world wide web, cellular and/or other arrangements for enabling communication between the processing devices 102, in either real time or otherwise (e.g., via time shifting, batch processing, etc.).

A processing device 102 can be implemented as a server, personal computer, laptop computer, netbook computer, purpose-driven appliance, special purpose computing device and/or other device capable of communicating over the network 104. Other types of processing devices 102 include for example, personal data assistant (PDA) processors, palm computers, cellular devices including cellular mobile telephones and smart telephones, tablet computers, an electronic control unit (ECU), a display of the industrial vehicle, etc.

Still further, a processing device 102 is provided on one or more autonomous or semiautonomous industrial vehicles 108 such as a forklift truck, reach truck, stock picker, automated guided vehicle, turret truck, tow tractor, rider pallet truck, walkie stacker truck, quick pick remote truck, etc. In the example configuration illustrated, the industrial vehicles 108 wirelessly communicate through one or more access points 110 to a corresponding networking component 106, which serves as a connection to the network 104. Alternatively, the industrial vehicles 108 can be equipped with Wi-Fi, cellular or other suitable technology that allows the processing device 102 on the industrial vehicle 108 to communicate directly with a remote device (e.g., over the networks 104).

The illustrated system 100 also includes a processing device implemented as a server 112 (e.g., a web server, file server, and/or other processing device) that supports an analysis engine 114 and corresponding data sources (collectively identified as data sources 116). The analysis engine 114 and data sources 116 provide domain-level resources to the industrial vehicles 108. Moreover, the data sources 116 store data related to activities of the industrial vehicles 108.

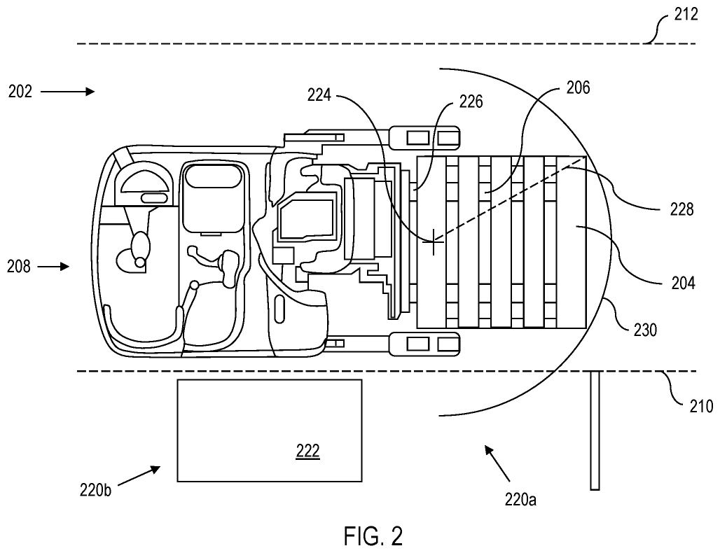

Turning now to FIG. 2, a top-down view of an aisle 202 is shown with a load 204 on a load-handling feature 206 of an industrial vehicle 208. The industrial vehicle 208 may be an autonomous vehicle or a semi-autonomous vehicle. A width of the aisle 202 is bounded by a first boundary 210 and a second boundary 212. Adjacent to the first and second boundaries 210, 212 are locations (e.g., storage areas) 220a-b where items 222 may be stored. These locations are putaway locations or pickup locations depending on whether items are stored there. Further, while FIG. 2 only shows two locations 220a-b and both locations are opposite the first boundary 210, more locations may be present opposite the second boundary 212 and more locations may be opposite to the first boundary. Moreover, an industrial environment may have numerous aisles similar to the aisle 202 of FIG. 2.

In order for most industrial vehicles 208 to access a location, the industrial vehicle 208 must be facing the location. However, the locations are usually not facing a general direction of travel (down a length of an aisle), so the industrial vehicle 208 must turn within the aisle 202 to face the location. Numerous autonomous and semiautonomous vehicles perform a pivot maneuver around a pivot point 224 that may be between portions of the load-handling feature to face the location. Thus, there must be enough room within the width of the aisle 202 for the industrial vehicle 208 to pivot about the pivot point 224 and approach the location (e.g., 220b in FIG. 2). However, due to the pivot point 224 being near a middle of the load-bearing feature, a radius 228 from the pivot point to a corner of the load-bearing feature (or load on the load-bearing feature) will be greater than a radius from the pivot point to an edge of the load or load-bearing feature. Thus, more space is required for an industrial vehicle while pivoting that is required after the pivot is completed, shown by arc 230.

According to aspects of the present disclosure, before an autonomous or semiautonomous industrial vehicle performs a pivot maneuver, the industrial vehicle uses sensors located on the industrial vehicle to determine if the location is clear before completing the pivot maneuver. For example, in some embodiments, the industrial vehicle includes sensors (e.g., cameras, light-based sensors, etc.) that detect objects, where the sensors face out from the industrial vehicle generally not in a direction of travel of the vehicle. In many embodiments, if a sensor used for locating objects while the industrial vehicle is traveling has a wide enough view/range, then that sensor may be used to detect objects in the putaway location. In various embodiments, the sensor is a sensor that is coupled to the load-bearing feature of the industrial vehicle.

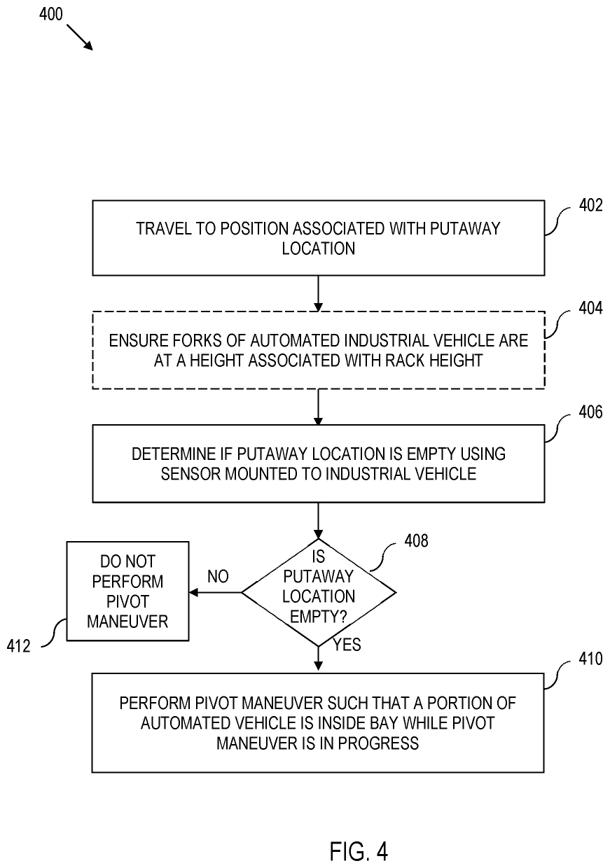

If there are no objects, then the industrial vehicle will perform a pivot maneuver where the load-bearing feature or the load (e.g., corners of the load or load-bearing feature) uses a portion of the object-free location while completing the pivot maneuver. For example, the sensor(s) can scan the location before the pivot maneuver is started or while the pivot maneuver is completing. However, the scan must be completed before the pivot maneuver is completed. The sensor scan is discussed in greater detail below in reference to FIG. 4. If there is an object detected in the putaway location, the industrial vehicle does not complete the pivot maneuver.

As discussed above, the putaway location may be at a height in the racking that is not ground level. As such, the industrial vehicle may need to raise the load-bearing feature to a correct height in the racking for the correct putaway location. Thus, it is important that the sensor that determines if the putaway location is free of objects is mounted to a portion of the load-bearing feature that gets raised. Thus, the industrial vehicle performs the pivot maneuver after the load-bearing feature is raised to a height associated with the putaway location.

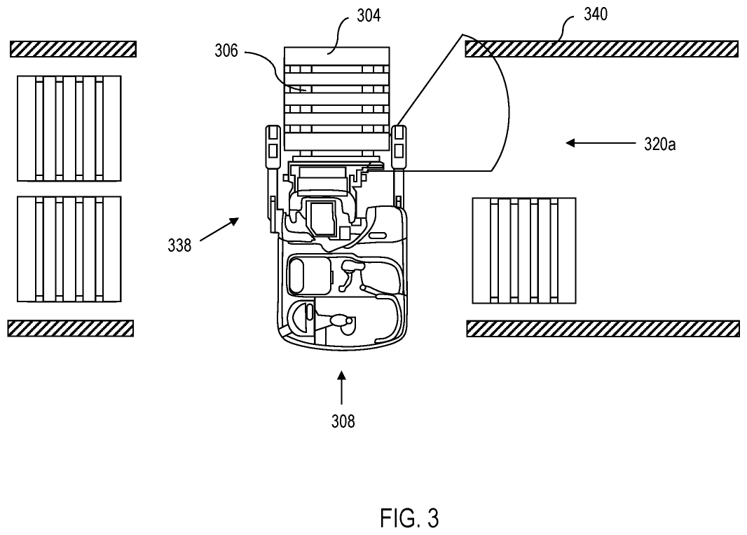

Turning now to FIG. 3, an example of an autonomous or semiautonomous industrial vehicle 308 after the vehicle has traveled to a putaway location 320a is shown. The industrial vehicle traveled to that location after receiving an instruction (e.g., from a server (see 112, FIG. 1)) to putaway a load 304. The industrial vehicle 308 includes a frame 338, and a load-bearing feature 306 (e.g., a set of forks where the industrial vehicle is a type of forklift) is coupled to the frame 338. The industrial vehicle 308 raises the set of forks (i.e., load-bearing feature) to a height associated with the putaway location. Then the industrial vehicle 308 activates a sensor coupled to a portion of the load-bearing feature that was raised to the height, so the sensor can scan the location for objects. In some embodiments, the sensor couples to the frame via the load-bearing feature.

The sensor detects racking 340 and determines that the location 320a is free from objects. In some embodiments, identifying a location of the racking 340 may help pinpoint the putaway location for the vehicle to scan for objects. Note that the sensor scan can happen before the industrial vehicle starts the pivot maneuver or while the pivot maneuver is in process. If an object is found in the location, then the industrial vehicle forgoes (if not started yet) or stops (if already started) the pivot maneuver. Further, detecting and identifying the racking also ensures that the racking is not harmed during the pivot maneuver, while a portion of the industrial vehicle or a portion of the load uses the putaway location while performing the pivot maneuver.

Turning now to FIG. 4, a process 400 for aligning an industrial vehicle for putaway operation is disclosed. At 402, the automated or semiautomated industrial vehicle travels to a position associated with a putaway location. The industrial vehicle receives an instruction to perform a putaway operation at the putaway location within an industrial environment, so the industrial vehicle travels to that position within the industrial environment. In some embodiments, the instruction to perform a putaway operation further includes a rack height associated with the putaway location. For example, the putaway location may include an aisle number, a rack number, and a rack height number.

After the industrial vehicle travels to the position associated with the putaway location, the industrial vehicle optionally raises a load-bearing feature of the industrial vehicle. For example, the industrial vehicle ensures that the load-bearing feature of the industrial vehicle is at a height associated with the putaway location. If the load-bearing feature (e.g., forks) are at the height associated with the putaway location (e.g., the putaway location is a ground level), then the industrial vehicle determines that the load-bearing feature is at the right height. However, if the load-bearing feature is not at the rack height associated with the putaway location, then the load-bearing feature is adjusted to be at the height associated with the putaway location.

At 404, a sensor coupled to the industrial vehicle determines whether the putaway location is empty (i.e., free of objects). As discussed above, the sensor scans the putaway location to determine if any unknown objects are present. For example, the sensor may be coupled to the industrial vehicle via the load-bearing feature such that the sensor is at a height associated with the putaway location when the load-bearing feature is at the rack height. In many embodiments, the sensor that scans the putaway location is not directed in a travel path of the industrial vehicle; instead the sensor scans an area generally perpendicular to the travel path. In various embodiments, the sensor is a camera, and video processing software is used to determine if the putaway location is empty. In several embodiments, to determine whether the putaway location is empty, the sensor detects a physical portion of the putaway location (e.g., racking (see 340, FIG. 3)) and then scans an area adjacent to the physical portion of the putaway location.

At 408, if no other objects (other than the physical portion of the putaway location) are detected in the putaway location, then the process advances to 410, where the industrial vehicle completes a pivot maneuver. As the industrial vehicle pivots around the pivot point (see 224, FIG. 2), a portion of the industrial vehicle (e.g., load-bearing feature, load on the load-bearing feature, etc.) is inside the putaway location at some point during the pivot maneuver. As discussed above, the pivot maneuver may be started before or after the putaway location is determined to be empty. However, the putaway location should be determined to be empty before the industrial vehicle completes the pivot maneuver. In many embodiments, the pivot maneuver is a static pivot maneuver such that the industrial vehicle does not traverse the industrial environment during the pivot maneuver.

Before the pivot maneuver is completed (and in various embodiments, before the pivot maneuver is started), if the industrial vehicle determines that there is an object in the putaway location (i.e., the putaway location is not empty), then the industrial vehicle will stop (or not commence) the pivot maneuver at 412 and perform some other predetermined action. For example, the predetermined action may be to report that the putaway location is not empty, to request a new putaway location, to travel to another location of the industrial environment and wait, to perform the putaway at a different/new putaway location, etc., or combinations thereof.

By utilizing a portion of the putaway location for a pivot maneuver, an industrial vehicle can pivot in an environment with narrower aisles than previously allowed and allows such vehicles to be used in an industrial environment with an allowed tolerance for a deviation from a known location (e.g., ten centimeters) without damaging the industrial vehicle, racking, items, or other parts of the industrial environment.

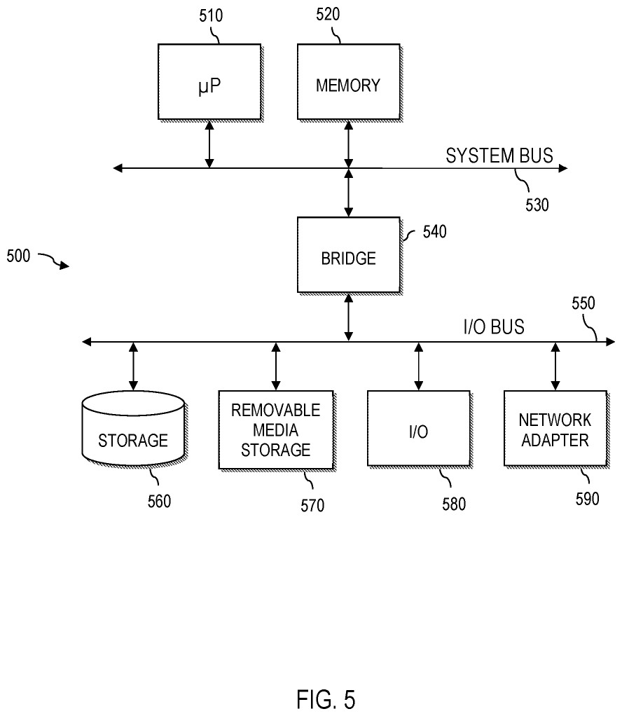

Referring to FIG. 5, a block diagram of a data processing system (i.e., computer system) is depicted in accordance with the present invention. Data processing system 500 may comprise a symmetric multiprocessor (SMP) system or other configuration including a plurality of processors 510 connected to system bus 530. Alternatively, a single processor 510 may be employed. Also connected to system bus 530 is local memory 520. An I/O bus bridge 540 is connected to the system bus 530 and provides an interface to an I/O bus 550. The I/O bus may be utilized to support one or more buses and corresponding devices 570, such as storage 560, removable media storage 570, input output devices (I/O devices) 580, network adapters 590, etc. Network adapters may also be coupled to the system to enable the data processing system to become coupled to other data processing systems or remote printers or storage devices through intervening private or public networks.

Also connected to the I/O bus may be devices such as a graphics adapter, storage and a computer usable storage medium having computer usable program code embodied thereon. The computer usable program code may be executed to implement any aspect of the present invention, for example, to implement any aspect of any of the methods and/or system components described herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using an Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for aligning an industrial vehicle for putaway operation, the process comprising:
traveling to a position associated with a putaway location in an industrial environment;
determining, via a sensor mounted to the industrial vehicle, whether the putaway location is empty; and
completing, after determining that the putaway location is empty, a pivot maneuver such that a portion of the industrial vehicle is inside the putaway location while the pivot maneuver is in progress.

2. The process of claim 1, wherein traveling to a position associated with a putaway location further comprises receiving an instruction to perform a putaway operation at the putaway location.

3. The process of claim 2, wherein receiving an instruction to perform a putaway operation at the putaway location comprises receiving the instruction to perform a putaway operation at the putaway location, wherein the putaway location includes a rack height.

4. The process of claim 3, further comprising ensuring a load-bearing feature of the industrial vehicle is at a height associated with the rack height before determining whether the putaway location is empty.

5. The process of claim 4, wherein ensuring a load-bearing feature of the industrial vehicle is at a height associated with the rack height comprises:
determining that the load-bearing feature is not at the height associated with the rack height; and
adjusting the load-bearing feature to be at the height associated with the rack height.

6. The process of claim 4, wherein ensuring a load-bearing feature of the industrial vehicle is at a height associated with the rack height comprises determining that the load-bearing feature is at the height associated with the rack height.

7. The process of claim 1, wherein determining, via a sensor mounted to the industrial vehicle, whether the putaway location is empty comprises determining, via a camera mounted to the industrial vehicle, whether the putaway location is empty, wherein the camera is not directed in a travel path of the industrial vehicle.

8. The process of claim 7, wherein determining, via a camera mounted to the industrial vehicle, whether the putaway location is empty comprises determining, via a camera mounted to a side of the industrial vehicle, whether the putaway location is empty.

9. The process of claim 1, wherein determining, via a sensor mounted to the industrial vehicle, whether the putaway location is empty further comprises:
detecting a physical portion of the putaway location; and
scanning an area adjacent to the physical portion of the putaway location to determine that the putaway location is free from obstacles.

10. The process of claim 1, further comprising performing a predetermined action if the putaway location is not empty.

11. The process of claim 10, wherein performing a predetermined action if the putaway location is not empty comprises traveling to another location of the industrial environment.

12. The process of claim 10, wherein performing a predetermined action if the putaway location is not empty comprises performing the putaway operation at another location of the industrial environment.

13. The process of claim 1, wherein completing, after determining that the putaway location is empty, a pivot maneuver further comprises performing the pivot maneuver without traversing during the pivot maneuver.

14. An industrial vehicle comprising:
a frame;
a load-handling feature coupled to the frame;
a sensor, wherein the sensor senses objects to a side of the industrial vehicle; and
a processor that executes instructions to:
travel to a position associated with a putaway location;
determine, via the sensor mounted to the industrial vehicle, whether the putaway location is empty, wherein the sensor is not directed in a travel path of the industrial vehicle; and
complete, after determining that the putaway location is empty, a pivot maneuver such that a portion of the industrial vehicle is inside the putaway location when the pivot maneuver is completed.

15. The industrial vehicle of claim 14, wherein the sensor is a camera.

16. The industrial vehicle of claim 14, wherein the load-handling feature is a set of forks.

17. The industrial vehicle of claim 14, wherein the instructions to:
travel to a position associated with a putaway location include instructions to receive an instruction to perform a putaway operation at the position, wherein the putaway location includes a rack height.

18. The industrial vehicle of claim 17, wherein the instructions further include instructions to ensure the load-handling feature of the industrial vehicle is at a height associated with the rack height before determining whether the putaway location is empty.

19. The industrial vehicle of claim 14, wherein the instructions further include instructions to perform a predetermined action if the putaway location is not empty.

20. The industrial vehicle of claim 14, wherein the sensor is coupled to the frame via the load-handling feature.
